(19) United States
(12) Patent Application Publication
(10) Pub. No.: US 2025/0031926 A1
(43) Pub. Date: Jan. 30, 2025

(54) VACUUM CLEANER TANK WITH BYPASS OPENING

(71) Applicant: MILWAUKEE ELECTRIC TOOL CORPORATION, Brookfield, WI (US)

(72) Inventors: Manas M. Mahaddalkar, Milwaukee, WI (US); Timothy J. Campbell, Brookfield, WI (US); Richard M. Schieber, Milwaukee, WI (US); Bradford A. Gill, Brookfield, WI (US); David Chikowski, West Allis, WI (US); Benjamin Teske, Milwaukee, WI (US)

(21) Appl. No.: 18/782,919

(22) Filed: Jul. 24, 2024

Related U.S. Application Data
(60) Provisional application No. 63/515,254, filed on Jul. 24, 2023.

(51) Int. Cl. A47L 9/14; A47L 9/32

(52) U.S. Cl. CPC A47L 9/1409; A47L 9/1463; A47L 9/32

(57) ABSTRACT

A vacuum cleaner including a top housing, a base, a suction source configured to generate a suction airflow, a tank positioned between the top housing and the base, and an actuator. The tank is configured to receive debris via the suction airflow. The tank includes an opening formed in an outer surface to the tank and a lid. The opening enables a user to provide debris directly into the tank, bypassing the suction airflow. The lid is moveable between a closed position where the lid fluidly seals the opening, and an open position where the opening fluidly connects an inner volume of the tank and a surrounding environment. The actuator is coupled to the tank and transitions the lid between the open position and the closed position.

### CROSS-REFERENCE TO RELATED APPLICATIONS

This application claims priority to pending U.S. Provisional Patent Application No. 63/515,254 filed on Jul. 24, 2023, the entire contents of which incorporated herein by reference.

### BACKGROUND

The present invention relates to vacuum cleaner and more particularly to a tank of a vacuum cleaner.

Vacuum cleaner includes a suction source configured to create a suction air flow through a nozzle to lift small debris from a surrounding environment. The suction air flow passes through a tank and the collected small debris are separated from the suction airflow and are left in the tank. In some instance, larger debris is unable to lifted by the suction airflow or are too large to fit through the nozzle. The tank of the vacuum cleaner may include an opening to receive the larger debris and a lid to close the opening.

### SUMMARY

In some aspects, the techniques described herein relate to a vacuum cleaner including: a top housing; a base; a suction source configured to generate a suction airflow; a tank positioned between the top housing and the base; the tank configured to receive debris via the suction airflow; the tank including: an opening formed in an outer surface of the tank through which a user is configured to provide debris directly into the tank, bypassing the suction airflow, and a lid moveable between a closed position where the lid fluidly seals the opening, and an open position where the opening fluidly connects an inner volume of the tank and a surrounding environment; and an actuator coupled to the tank; the actuator configured to transition the lid between the open position and the closed position.

In some aspects, the techniques described herein relate to a vacuum cleaner, wherein the tank includes a first tank portion and a second tank portion, wherein the second tank portion is stacked atop the first tank portion, and wherein the opening is formed on the second tank portion and the lid is coupled to the second tank portion.

In some aspects, the techniques described herein relate to a vacuum cleaner, wherein the lid is biased towards the closed position, and wherein the lid transitions from the open position to the closed position when a biasing force on the lid exceeds a force applied to the actuator.

In some aspects, the techniques described herein relate to a vacuum cleaner, wherein the actuator and the lid pivot, and wherein pivoting of the actuator in a first direction also results in pivoting of the lid in the first direction.

In some aspects, the techniques described herein relate to a vacuum cleaner, wherein the lid further includes a handle graspable by the user to transition the lid between the open position and the closed position.

In some aspects, the techniques described herein relate to a vacuum cleaner, wherein the actuator and the lid are coupled together via a plurality of linkages.

In some aspects, the techniques described herein relate to a vacuum cleaner, wherein the lid includes a handle graspable by the user to transition the lid between the open position and the closed position, wherein the handle of the lid includes a plurality of recesses, and wherein the plurality of linkages is coupled to the plurality of recesses.

In some aspects, the techniques described herein relate to a vacuum cleaner, wherein the lid further includes a guide configured to direct debris into the opening.

In some aspects, the techniques described herein relate to a vacuum cleaner, further including a seal positioned around an outer periphery of the opening against which the lid seals in the closed position.

In some aspects, the techniques described herein relate to a vacuum cleaner, wherein the base contacts a ground plane, wherein the tank defines at least one vertical side wall orthogonal to the ground plane, and wherein the opening, the lid, and the actuator are all positioned on the same sidewall defined by the tank.

In some aspects, the techniques described herein relate to a vacuum cleaner including: a top housing; a base; a suction source positioned within the top housing and configured to generate a suction airflow; a tank positioned between the top housing and the base; the tank configured to receive the suction airflow; the tank including: a first tank portion coupled to the base, a second tank portion is stacked atop the first tank portion, the second tank portion including: an opening formed in an outer surface of the tank through which a user is configured to provide debris directly into the tank, bypassing the suction airflow, and a lid movable between a closed position where the lid fluidly seals the opening, and an open position where the opening fluidly connects an inner volume of the tank and a surrounding environment such that a user is configured to provide debris directly into the tank, bypassing the suction airflow.

In some aspects, the techniques described herein relate to a vacuum cleaner, wherein the lid is biased towards the closed position, and wherein the lid transitions from the open position to the closed position when a biasing force on the lid exceeds a force applied to the actuator.

In some aspects, the techniques described herein relate to a vacuum cleaner, wherein an actuator is coupled to the tank and the actuator configured to transition the lid between the open position and the closed position, and wherein the actuator and the lid pivot, and wherein pivoting of the actuator in a first direction also results in pivoting of the lid along the lid axis in the first direction.

In some aspects, the techniques described herein relate to a vacuum cleaner, wherein the actuator and the lid are coupled together a plurality of linkages.

In some aspects, the techniques described herein relate to a vacuum cleaner, wherein the lid further includes a handle graspable by the user to transition the lid between the open position and the closed position.

In some aspects, the techniques described herein relate to a vacuum cleaner, wherein the handle of the lid includes a first set of recesses, a second set of recesses, and a third set of recesses, wherein the plurality of linkages is coupled to either the first set of recesses, the second set of recesses, or the third set of recesses.

In some aspects, the techniques described herein relate to a vacuum cleaner, wherein transitioning the lid from the closed position to the open position pivots the lid to either a first rotational offset, a second rotational offset, or a third rotational offset away from the opening corresponding to whether the plurality of linkages is coupled to the first set of recesses, the second set of recesses, or a third set of recesses.

In some aspects, the techniques described herein relate to a vacuum cleaner, wherein the lid axis is defined by a hinge coupled to the second tank portion.

In some aspects, the techniques described herein relate to a vacuum cleaner, wherein the lid includes a set of guides, wherein in the open position the set of guides are configured to direct debris into the opening, and wherein in the closed position the set of guides extend through the opening into the inner volume the tank.

In some aspects, the techniques described herein relate to a vacuum cleaner including: a top housing; a base; a suction source configured to generate a suction airflow; a tank positioned between the top housing and the base; the tank configured to receive the suction airflow; the tank including: a first tank portion coupled to the base, a second tank portion is stacked atop the second tank portion, the second tank portion including: an opening formed in an outer surface of the tank through which a user is configured to provide debris directly into the tank, bypassing the suction airflow, and a lid defining a handle integrally formed on a surface of the lid, the lid being pivotable along a lid axis between a closed position where the lid fluidly seals the opening, and an open position where the opening fluidly connects an inner volume of the tank and a surrounding environment; an actuator coupled to the tank; the actuator configured to transition the lid between the open position and the closed position, a linkage coupled to the actuator and the lid, wherein the lid is openable from the closed position to the open position via a user input to the actuator, and wherein the lid is openable from the closed position to the open position via a user input to the handle.

### BRIEF DESCRIPTION OF THE DRAWINGS

FIG. 1 illustrates a perspective view of a vacuum cleaner.

FIG. 2 illustrates an alternate perspective view of the vacuum cleaner of FIG. 1.

FIG. 3 illustrates a side view of the vacuum cleaner of FIG. 1.

FIG. 4 illustrates a side section view along line 4-4 of the vacuum cleaner of FIG. 1.

FIG. 5 illustrates a perspective view of a tank portion of the vacuum cleaner of FIG. 1.

FIG. 6 illustrates an alternate perspective view of the tank portion of FIG. 5.

FIG. 7 illustrates a perspective view of another embodiment of a vacuum cleaner.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

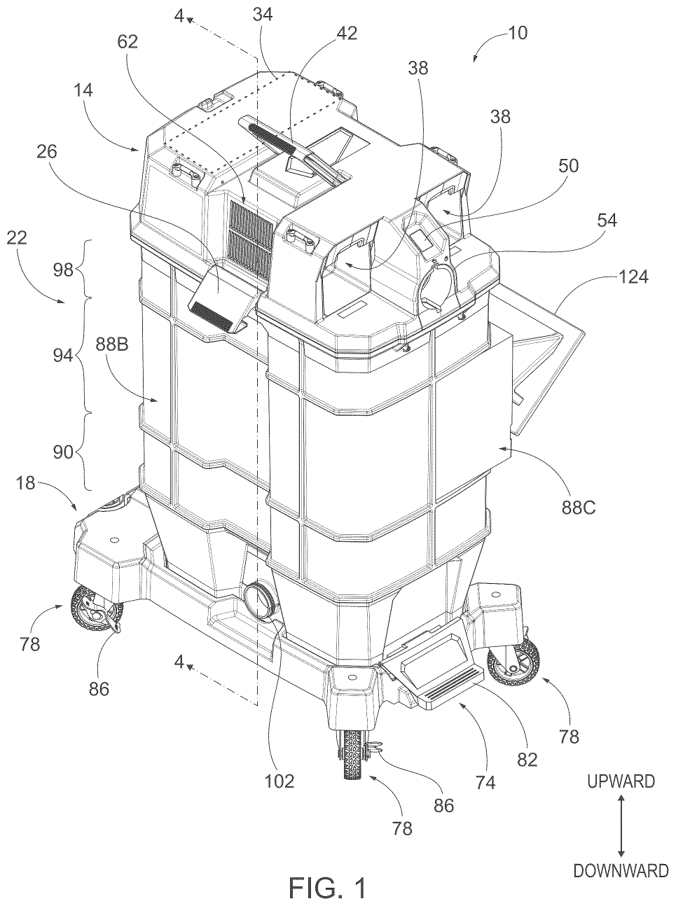

FIGS. 1-4 illustrates a vacuum cleaner 10 according to an embodiment of the present disclosure. The vacuum cleaner 10 is configured to collect and debris (e.g., dust, wood shavings, metal shavings, or fluid). As shown in FIGS. 1-4, the vacuum cleaner 10 includes a top housing 14, a base 18, and a tank 22. In other embodiments, the vacuum cleaner 10 may include a base 18 that is integrally formed into the tank 22.

With continued reference to FIGS. 1-4, the top housing 14 is positioned above the tank 22 and is coupled to tank 22 via a latch 26. In the illustrated embodiment, the top housing 14 includes two latches 26 formed on opposing sides, and each latch 26 is received within a latch recess integrally formed on the tank 22. In other embodiments, the top housing 14 may be coupled to the tank 22 with more or less than 2 latches or may be coupled via a press fit, a plurality of clips, or a plurality of thumb screws. The top housing 14 comprises a suction source 34, a plurality of battery bays 38, and a handle 42.

The suction source 34 is positioned within the top housing 14 and is configured to create a suction airflow used to collect debris. In some embodiments, the suction source 34 is a motor (not shown) configured to rotate a fan (not shown). The suction source 34 is selectively powered by a plurality of battery packs (not shown) positioned in the battery bays 38. A switch 50, positioned on the top housing 14, is used to determine when to electrically connect the suction source 34 with the battery packs. In other embodiments, the vacuum cleaner 10 may include an AC power input, which may alternatively be used to power the suction source 34.

In operation, the suction source 34 is powered and generates the suction airflow to draw debris in from a suction inlet 54. The suction inlet 54 is configured to receive a hose (not shown) connected to a nozzle (not shown) to extend the reach of the user and collect debris in a targeted area. The suction airflow draws debris into the nozzle, through the hose, and into the tank 22. Once in the tank 22, some of the debris is separated from the suction airflow and falls to the bottom of the tank 22. The suction airflow exits the tank 22 through a filter 58, which separates the remaining debris from the suction airflow. Once past the filter 58, the suction airflow exits through an exhaust 62 or a blower port 66 formed in the top housing 14.

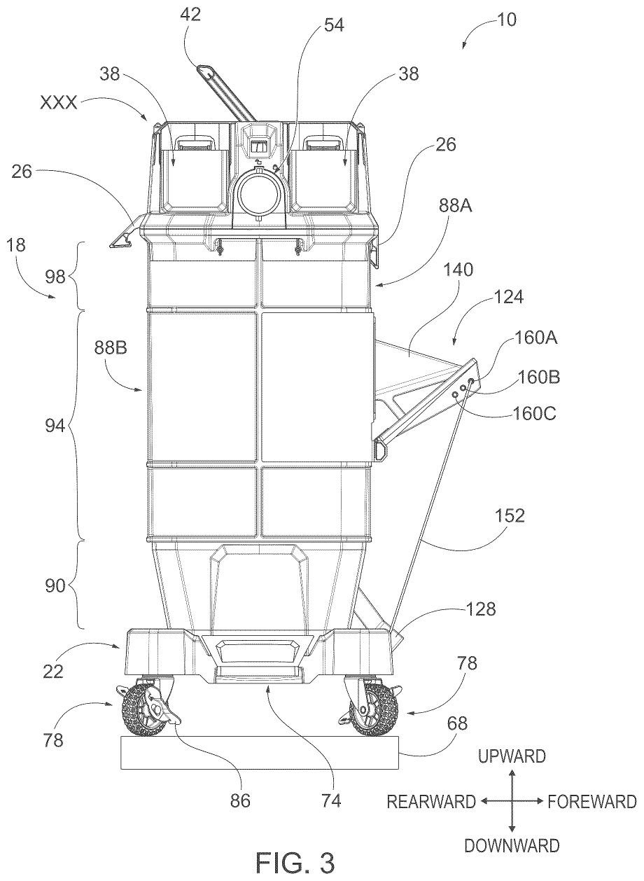

As shown in FIGS. 1 and 3, the top housing 14 includes 2 battery bays 38 each configured to receive one battery pack. The battery bays 38 includes a battery pack interface (not shown) to mechanically and electrically connect the battery packs to the vacuum cleaner 10. In some embodiments, the vacuum cleaner 10 is operable with only one battery pack installed at a reduced power or for a reduced runtime. In other embodiments, the top housing 14 may include only 1 battery bay or more than 2 battery bays.

As shown in FIGS. 1, 3, and 4, the handle 42 is positioned on a top surface of the top housing 14. The handle 42 is moveable between a storage position and an operational position. In the storage position, the handle 42 is lies against the top surface of the top housing 14 to reduce the overall footprint of the vacuum cleaner 10. In the operational position, the handle 42 no longer lies against the top surface and allows the user to grasp the handle 42 to reposition the vacuum cleaner 10. In other embodiments, the vacuum cleaner 10 may include more than one handle 42 and the handle 42 may be stationary in a single position.

As shown in FIGS. 1-4, the base 18 is positioned below the tank 22 and is configured to support and transport the remainder of the vacuum cleaner 10 on a ground plane 68. In the illustrated embodiment, the base 18 includes a tank recess 70, a foot pedal 74, and a plurality of caster wheels 78.

The tank recess 70 is shaped to receive a portion of the tank 22. The foot pedal 74 partially extends into the tank recess 70 below the tank 22 and includes a user engageable portion 82. In the illustrated embodiment, the user inserts the tank 22 into the tank recess 70 of the base 18 and contacts a portion of the foot pedal 74. To remove the tank 22 from the tank recess 70, the user applies a force to the user engageable portion 82 to pivot the foot pedal 74, which lifts the tank 22 out of the tank recess 70. In other embodiments, the tank 22 may be coupled to the base 18 via a press fit, one or more latches, or magnetically.

As shown in FIGS. 1-4, the base 18 includes 4 caster wheels 78 configured to reduce the effort required to move the base 18 on the ground plane 68. Additionally, at least one of the caster wheels 78 include a caster brake 86 for breaking the caster wheels 78 and preventing movement of the base 18. In other embodiments, the base 18 may include 2 caster wheels 78 and two straight wheels or the base 18 may include non-slip feet or other supporting members to keep the base in a stable orientation.

As shown in FIGS. 1-4, the tank 22 is positioned between and coupled to the top housing 14 and the base 18. The tank 22 defines a front side wall 88A, a rear side wall 88B, a right side wall 88C, a left side wall 88D, and a tank inner volume. Each of the side walls 88A-D are vertical and orthogonal to the ground plane 68. Additionally, the tank 22 is composed of a first tank portion 90 defining a first inner volume, a second tank portion 94 defining a second inner volume 96, and a third tank portion 98 defining a third inner volume. When each of the tank portions 90, 94, 98 are coupled together, the first, second, and third inner volumes are combined to form the tank inner volume.

With continued reference to FIGS. 1-4, the first tank portion 90 is tapered and is coupled to the base 18 and the second tank portion 94. Specifically, the first tank portion 90 is received within the tank recess 70 of the base 18. Additionally, the first tank portion 90 is coupled to the second tank portion 94 via the latches 26 received in latch recesses (not shown) formed in the first tank portion 90. Additionally, the first tank portion 90 includes a fluid outlet 102 and an actuator recess 106. The fluid outlet 102 selectively connects the tank inner volume with the surrounding environment and allows fluid accumulated in the tank inner volume to be emptied. The fluid outlet 102 sealed with a cap (not shown) threaded onto the fluid outlet 102. In other embodiments, the fluid outlet 102 may be sealed by a plug or may include a valve to open or close the fluid outlet 102. The actuator recess 106 is integrally formed on the front side wall 88A and is shaped to receive a foot pedal 74.

With continued reference to FIGS. 1-4, the third tank portion 98 is coupled to the top housing 14 and is stacked on top of the second tank portion 94. Specifically, the third tank portion 98 is coupled the top housing 14 by receiving the latches 26 of the top housing 14 in the latch recesses of the third tank portion 98. The third tank portion 98 is coupled to the second tank portion 94 by coupling the latches 26 of the third tank portion 98 to a set of latch recesses 112 of the second tank portion 94. In other embodiments, the tank 22 may be include a different third tank portion with a greater or a reduced height to increases or decrease tank inner volume. In further embodiments, the third tank portion 98 may be omitted and the top housing 14 may be directly coupled to the second tank portion 94.

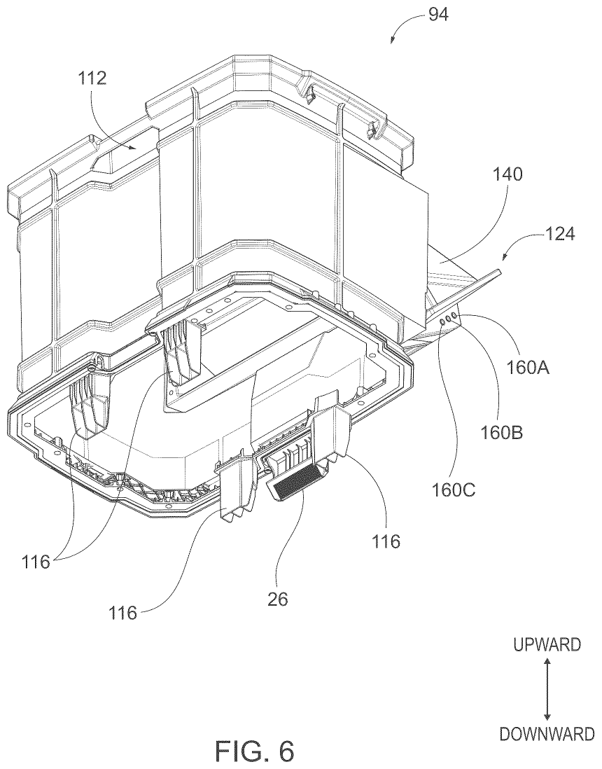

With continued reference to FIGS. 1-4, the second tank portion 94 is positioned between and coupled to the first tank portion 90 and the third tank portion 98. To couple to the third tank portion 98, the second tank portion 94 includes the latch recesses 112 integrally formed on the front side wall 88A and the rear side wall 88B. In other embodiments, the second tank portion 94 may include more than 2 latch recesses 112 and may be formed on some combination of the front, rear, right, or left side walls 88A-D. To couple to the first tank portion 90, the second tank portion 94 includes at least one latch 26 and a plurality of protrusions 116. The latch 26 is rotatable about an axis to selectively engage the latch recess (not shown) formed on the first tank portion 90. As shown in FIG. 6, the plurality of protrusions 116 are positioned on either side of the latch 26 and extend downward into a receiving region (not shown) in the first tank portion 90 to align the second tank portion 94 with the first tank portion 90. Additionally, the third tank portion 98 also includes a plurality of protrusions to align the third tank portion 98 with the second tank portion 94. In other embodiments, the protrusions 116 may be replaced with a continuous lip extending along the bottom surface of the second tank portion 94 and the third tank portion 98 to assist with alignment.

As shown in FIGS. 1-6, the tank 22 further includes an opening 120 configured to receive debris too large to fit through the nozzle and the hose of the vacuum cleaner 10. The tank 22 also includes a lid 124 configured to selectively seal the opening 120 and a lid actuator 128 configured to move the lid 124 to either seal or unseal the opening 120.

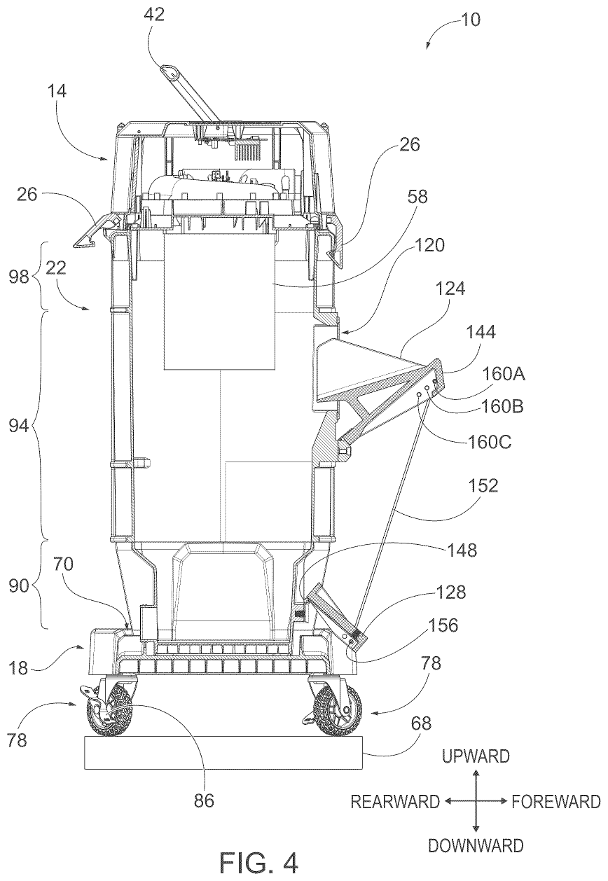

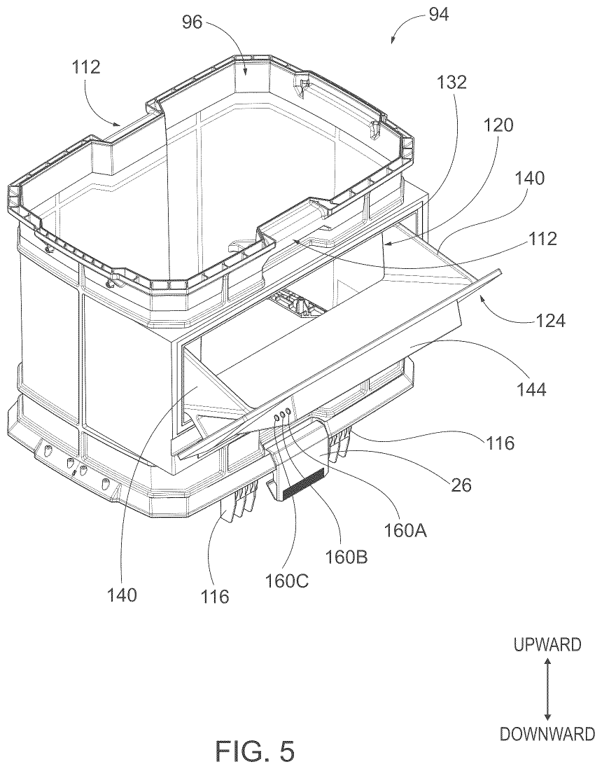

As shown in FIGS. 4-5, the opening 120 is formed on the front side wall 88A of the second tank portion 94 and is rectangular. The opening 120 is configured to fluidly connect the tank inner volume and the surrounding environment of the vacuum cleaner 10. The opening 120 includes a seal 132 positioned along the periphery edge of the opening 120. The seal 132 is configured to create a fluid tight seal when the lid 124 abuts the outer surface of the seal 132. In other embodiments, the opening 120 may be formed on one of the other side walls 88B-C of the tank 22 and may be formed on a different tank portion 90, 98. In further embodiments, the opening may be square-shaped or slot-shaped.

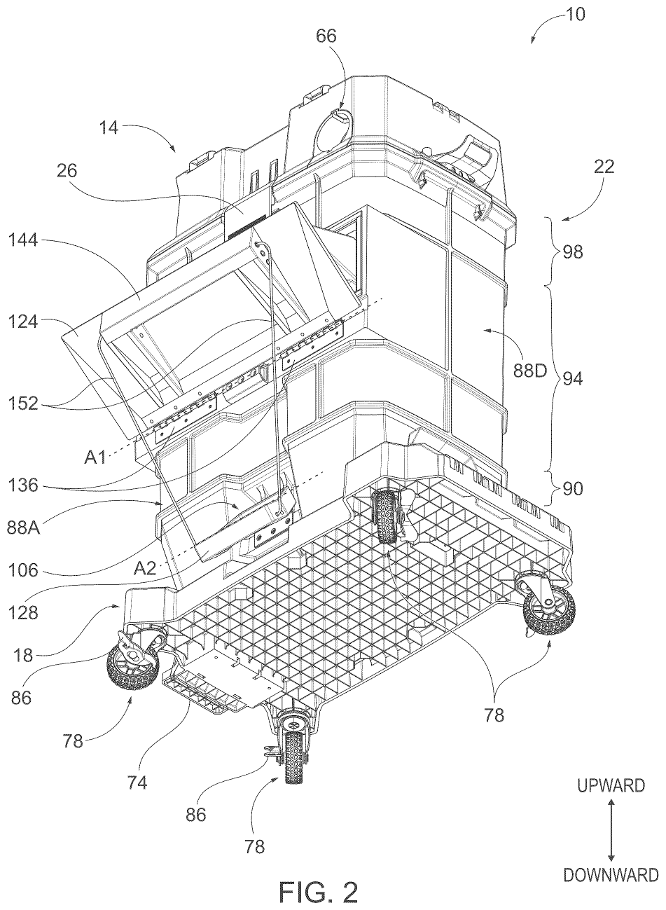

As shown in FIGS. 1-6, the lid 124 is coupled to the front side wall 88A of the second tank portion 94 via a plurality of hinges 136. As shown in FIG. 2, the plurality of hinges 136 define a lid axis A1 on which the lid 124 rotates. In some embodiments, the hinges 136 may be spring-loaded to bias the lid 124 in a specific rotational direction. In other embodiments, the hinges 136 may be omitted and the lid 124 and the tank 22 may be directly rotatably connected. The lid 124 is moveable between an open position and a closed position. In the open position (FIGS. 2-5), the lid 124 is rotated along the lid axis A1 away from the opening 120. When the lid 124 is moved away from the opening 120, the tank inner volume is fluidly connected to the surrounding environment, and a user can deposit debris into the tank 22. In the closed position, the lid 124 rests against the opening 120 and abuts the seal 132. As a result, the tank inner volume is fluidly sealed, and no debris can enter or leave through the opening 120. In the illustrated embodiment, the lid 124 is normally biased toward the closed position and requires a force greater than a biasing force threshold to transition the lid 124 from the closed position. In some embodiments, the lid 124 may include a retention mechanism to keep the lid 124 in the closed position. Some instances of retention mechanism may be a latch positioned on the lid or a plurality of magnets The lid 124 includes a set of guides 140 and a handle 144.

As shown in FIGS. 1-6, the set of guides 140 of the lid 124 are formed on an inner surface (faces the tank inner volume in the closed position) of the lid 124. When the lid 124 is in the open position, the guides 140 are configured to direct debris deposited by the user into the opening 120 and reduce the likelihood of debris falling outside the opening 120. When in the closed position, the guides 140 extend into the opening 120 and the tank inner volume. In other embodiments, the guides 140 may be separate from the lid 124 and may extend from the opening 120 when the lid 124 is in the open position.

As shown in FIGS. 2-5, the handle 144 of the lid 124 is formed on an outer surface (facing away from the tank inner volume in the closed position) of the lid 124. In the illustrated embodiment, the handle 144 is formed along a portion of the top edge of the lid 124. In other embodiments, the handle 144 may extend along the entire top edge or may be a separate component that is coupled to the lid 124. In operation, the handle 144 is graspable by the user to transition the lid 124 between the open and closed positions.

As shown in FIGS. 2-4, the lid actuator 128 is coupled to the front side wall 88A of the first tank portion 90 in the actuator recess 106 via an actuator hinge 148. As shown in FIG. 2, the actuator hinge 148 defines an actuator axis A2 about which the lid actuator 128 pivots. Pivoting of the lid actuator 128 results in the lid 124 transitioning between the closed and open positions. In other embodiments, the lid actuator 128 moves along a linear axis or elastically deforms to transition the lid 124 between the closed and the open positions.

To transmit motion between the lid actuator 128 and the lid 124, a plurality of linkages 152 are coupled to each. Specifically, the plurality of linkages 152 are inserted into a linkage recess 156 of the lid actuator 128 and are inserted into either a first plurality of recesses 160A, a second plurality of recesses 160B, or a third plurality of recesses 160C formed in the handle 144 of the lid 124. The user selects whether to couple the linkages 152 to the first, second, or third plurality of recesses 160A-C based a desired rotational offset of the lid 124 from the tank 22 in the open position. If the linkages 152 are coupled to the first plurality of recesses 160A, the lid 124 in the open position will have a first rotational offset. If the linkages 152 are coupled to the second plurality of recesses 160B, the lid 124 in the open position will have a second rotational offset larger than the first rotational offset. If the linkages 152 are coupled to the third plurality of recesses 160C, the lid 124 in the open position will have a third rotational offset larger than the first rotational offset and the second rotational offset. In other embodiment, the handle 144 of the lid 124 may include additional or fewer pluralities of recesses to have additional or fewer rotational offset choices for the user. In further embodiments, the plurality of linkages 152 may be replaced with a chain, a cable, or a belt linking the motion of the lid actuator 128 and the lid 124.

In use, the user utilizes the vacuum cleaner 10 to collect debris from the surrounding environment. In a first scenario, the user would like to collect smaller debris. As a result, the user may couple a hose including a nozzle to the suction inlet 54 and move the switch 50 to the “On” position. In the “On” position, the switch 50 electrically connects the battery packs to the suction source 34, and a suction airflow is generated. The suction airflow is configured to draw debris in through the nozzle and the hose into the tank 22. Once in the tank 22, the debris is separated from the suction airflow and is deposited in the tank inner volume. The suction airflow exits the tank through the filter 58 and out of the exhaust 62 or the blower port 66.

In a second scenario, the user would like to collect debris that would not fit through the suction inlet 54 or is too heavy for the suction airflow to collect. Therefore, the user needs to bypass the suction inlet 54 using the opening 120 to deposit the debris into the tank 22. Normally, the lid 124 blocks the opening 120 and prevents depositing debris. To unblock the opening 120, the user can grasp the handle 144 and rotate the lid 124 away from the opening 120. Alternatively, the user can apply a force to pivot the lid actuator 128 about the actuator axis A2 in the first direction. When the force applied to the lid actuator 128 exceeds a biasing force threshold, the linkages 152 move downward, and the lid 124 moves away from the opening 120 in the first direction (the open position). The rotational displacement of the lid 124 is proportional to the rotational displacement of the lid actuator 128. The maximum rotational displacement of the lid 124 is dependent on whether the linkages 152 are coupled to the first, second, or third set of recesses 160A-C. When the lid 124 is moved away from the opening 120, the lid 124 no longer obstructs the opening 120, which enables the user to deposit the debris into the tank 22. After the debris has been deposited into the tank 22, the user reduces the applied force or stops applying force to the lid actuator 128. When the applied force falls below the biasing force threshold, the lid 124 returns towards the opening 120. The lid 124 rotates about the lid axis A1 in a second direction opposite to the first direction, until the inner surface of the lid 124 abuts the seal 132 of the opening 120 (the closed position). At this point, the opening 120 is fluidly sealed and no debris can enter or exit the debris from the opening 120.

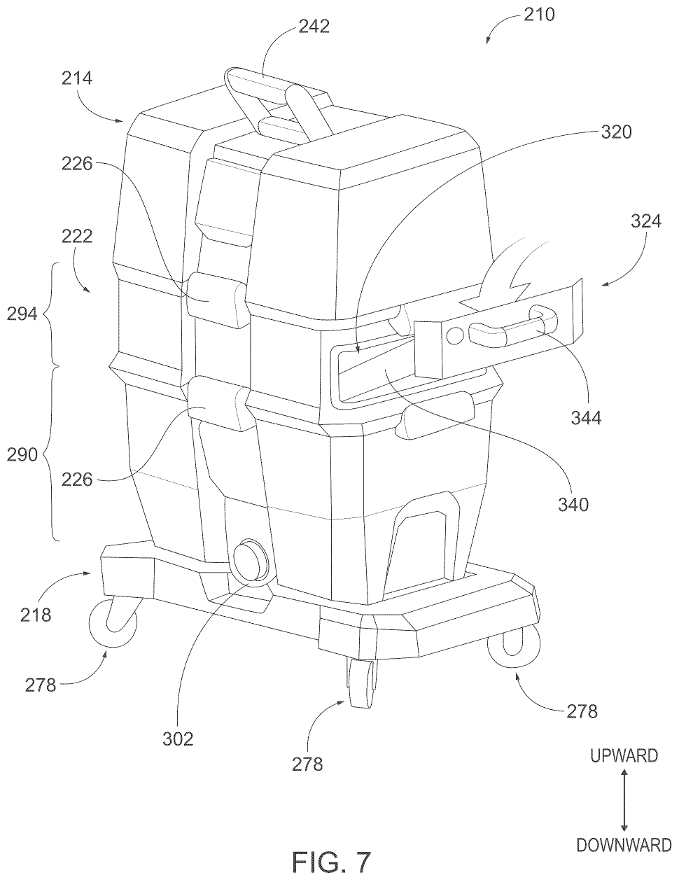

FIG. 7 illustrates another embodiment of a vacuum cleaner 210 with like parts to the vacuum cleaner 10. The illustrated embodiment of FIG. 7 having like reference numerals plus “200,” and the differences are explained below. The vacuum cleaner 210 includes a top housing 214, a base 218, and a tank 222. The tank 222 defines a tank inner volume configured to store debris and is composed of a first tank portion 290 and a second tank portion 294. The second tank portion 294 includes an opening 320 and a lid 324 moveable between an open position and a closed position. In the closed position, the lid 324 abuts an outer surface of the second tank portion 294 and prevents debris from entering the tank 22 through the opening 320. To transition the lid 324 between the closed and open position, the user pulls on a handle 344 to move (e.g., slide) the lid 324 in an upward and an outward direction. In the open position, the lid 324 is moved away from the opening 320 to allow the user to deposit debris into the tank inner volume through the opening 320. When in the open position, the lid 324 exposes a guide 340, which functions as a ramp to guide debris into the opening 320. In this embodiment, no actuator is used with the lid 324. The lid 324 and guide 340 may be biased toward the closed position with a spring (not shown). In addition, the lid 324 and guide 340 may include a latch disposed on the lid 324 or the second tank portion 294 which acts to latch the lid 324 in the closed position. The latch must be released to allow the lid 324 to be moved to the open position with the handle 344. The latch can automatically catch when the lid 324 is returned to the closed position.

1. A vacuum cleaner comprising:
a top housing;
a base;
a suction source configured to generate a suction airflow;
a tank positioned between the top housing and the base; the tank configured to receive debris via the suction airflow; the tank comprising:
an opening formed in an outer surface of the tank through which a user is configured to provide debris directly into the tank, bypassing the suction airflow, and
a lid moveable between a closed position where the lid fluidly seals the opening, and an open position where the opening fluidly connects an inner volume of the tank and a surrounding environment; and
an actuator coupled to the tank; the actuator configured to transition the lid between the open position and the closed position.

2. The vacuum cleaner of claim 1, wherein the tank includes a first tank portion and a second tank portion, wherein the second tank portion is stacked atop the first tank portion, and wherein the opening is formed on the second tank portion and the lid is coupled to the second tank portion.

3. The vacuum cleaner of claim 1, wherein the lid is biased towards the closed position, and wherein the lid transitions from the open position to the closed position when a biasing force on the lid exceeds a force applied to the actuator.

4. The vacuum cleaner of claim 1, wherein the actuator and the lid pivot, and wherein pivoting of the actuator in a first direction also results in pivoting of the lid in the first direction.

5. The vacuum cleaner of claim 1, wherein the lid further comprises a handle graspable by the user to transition the lid between the open position and the closed position.

6. The vacuum cleaner of claim 1, wherein the actuator and the lid are coupled together via a plurality of linkages.

7. The vacuum cleaner of claim 6, wherein the lid includes a handle graspable by the user to transition the lid between the open position and the closed position, wherein the handle of the lid includes a plurality of recesses, and wherein the plurality of linkages is coupled to the plurality of recesses.

8. The vacuum cleaner of claim 1, wherein the lid further comprises a guide configured to direct debris into the opening.

9. The vacuum cleaner of claim 1, further comprising a seal positioned around an outer periphery of the opening against which the lid seals in the closed position.

10. The vacuum cleaner of claim 1, wherein the base contacts a ground plane, wherein the tank defines at least one vertical side wall orthogonal to the ground plane, and wherein the opening, the lid, and the actuator are all positioned on the same sidewall defined by the tank.

11. A vacuum cleaner comprising:
a top housing;
a base;
a suction source positioned within the top housing and configured to generate a suction airflow;
a tank positioned between the top housing and the base; the tank configured to receive the suction airflow; the tank comprising:
a first tank portion coupled to the base,
a second tank portion is stacked atop the first tank portion, the second tank portion comprising:
an opening formed in an outer surface of the second tank portion through which a user is configured to provide debris directly into the tank, bypassing the suction airflow, and
a lid movable between a closed position where the lid fluidly seals the opening, and an open position where the opening fluidly connects an inner volume of the tank and a surrounding environment such that a user is configured to provide debris directly into the tank, bypassing the suction airflow.

12. The vacuum cleaner of claim 11, wherein the lid further comprises a handle graspable by the user to transition the lid between the open position and the closed position.

13. The vacuum cleaner of claim 12, wherein the lid includes a set of guides, wherein in the open position the set of guides are configured to direct debris into the opening, and wherein in the closed position the set of guides extend through the opening into the inner volume the tank.

14. The vacuum cleaner of claim 12, further comprising an actuator coupled to the first tank portion and configured to transition the lid between the open position and the closed position, wherein the lid is pivotable along a lid axis, wherein the lid is biased towards the closed position, and wherein the lid transitions from the open position to the closed position when a biasing force on the lid exceeds a force applied to the actuator.

15. The vacuum cleaner of claim 14, wherein the actuator and the lid pivot, and wherein pivoting of the actuator in a first direction also results in pivoting of the lid along the lid axis in the first direction.

16. The vacuum cleaner of claim 15, wherein the actuator and the lid are coupled together via a plurality of linkages.

17. The vacuum cleaner of claim 16, wherein the handle of the lid includes a first set of recesses, a second set of recesses, and a third set of recesses, wherein a plurality of linkages is coupled to either the first set of recesses, the second set of recesses, or the third set of recesses.

18. The vacuum cleaner of claim 17, wherein transitioning the lid from the closed position to the open position pivots the lid to either a first rotational offset, a second rotational offset, or a third rotational offset away from the opening corresponding to whether the plurality of linkages is coupled to the first set of recesses, the second set of recesses, or a third set of recesses.

19. The vacuum cleaner of claim 18, wherein the lid axis is defined by a hinge coupled to the second tank portion.

20. A vacuum cleaner comprising:
a top housing;
a base;
a suction source configured to generate a suction airflow;
a tank positioned between the top housing and the base; the tank configured to receive the suction airflow; the tank comprising:
a first tank portion coupled to the base,
a second tank portion is stacked atop the second tank portion, the second tank portion comprising:
an opening formed in an outer surface of the tank through which a user is configured to provide debris directly into the tank, bypassing the suction airflow, and
a lid defining a handle integrally formed on a surface of the lid, the lid being pivotable along a lid axis between a closed position where the lid fluidly seals the opening, and an open position where the opening fluidly connects an inner volume of the tank and a surrounding environment;
an actuator coupled to the tank; the actuator configured to transition the lid between the open position and the closed position,
a linkages coupled to the actuator and the lid,
wherein the lid is openable from the closed position to the open position via a user input to the actuator, and
wherein the lid is openable from the closed position to the open position via a user input to the handle.
